(19) United States
(12) Patent Application Publication
(10) Pub. No.: US 2014/0282019 A1
(43) Pub. Date: Sep. 18, 2014

(54) Systems And Methods For Generating Software Components

(71) Applicant: THEPLATFORM MEDIA, INC., Seattle, WA (US)

(72) Inventors: Alan Ramaley, Seattle, WA (US); Nick Rossi, Seattle, WA (US); Dave Edelstein, Seattle, WA (US)

(73) Assignee: thePlatform Media, Inc., Seattle, WA (US)

(21) Appl. No.: 13/828,192

(22) Filed: Mar. 14, 2013

(51) Int. Cl. G06F 3/0484

(52) U.S. Cl. CPC G06F 3/04842
USPC 715/735

(57) ABSTRACT

Systems and methods for generating software components are disclosed. In an aspect, one method can comprise receiving one or more configuration options, wherein each of the one or more configuration options comprises parameter information and mapping each option to an interface element based. The method may further comprise presenting an interface comprising one or more of the interface elements, receiving a selection of the one or more interface elements, and generating a software component such as a plug-in instance based upon the one or more configuration options.

### BACKGROUND

Many software systems support a plug-in model for extensions. A plug-in can be a software component such as a piece of executable code that extends the base functionality of the system. A plug-in combined with a set of configuration values creates a plug-in instance. For example, a plug-in instance based on a plug-in for cropping images requires configuration values for the height and the width of the image to capture. There is a need for easy configuration of plug-ins, such as in an administrative console. Furthermore, current systems and methods do not provide sufficient means to automatically generate interfaces based on a set of configuration definitions. These and other shortcomings are identified and addressed by the disclosure.

### SUMMARY

It is to be understood that both the following general description and the following detailed description are exemplary and explanatory only and are not restrictive, as claimed. Provided are methods and systems for generating software components for adding abilities to applications, often referred to as plug-ins. In an aspect, an interface such as a user interface or API is automatically generated and/or updated to define and present selectable configuration parameters for a particular plug-in.

In an aspect, methods for generating a software component such as a plug-in instance can comprise receiving one or more configuration options. As an example, each of the one or more configuration options can comprise parameter information. Each of the one or more configuration options can be mapped to an interface element based on the parameter information associated with the one or more configuration options. An interface such as a user interface or an application programming interface (API) comprising one or more of the interface elements can be presented to a user. Accordingly, a selection of the one or more interface elements can be received. A software component can be generated based upon the one or more configuration options mapped to the select one or more interface elements.

In another aspect, methods for generating a software component such as a plug-in instance can comprise receiving a selection of a plug-in identifier and receiving one or more configuration options associated with the plug-in identifier. As an example, each of the one or more configuration options comprises parameter information. An interface element (e.g., user interface, API) can be generated for each of the one or more configuration options based on the identifier and parameter information associated with the one or more configuration options. As an example, each of the generated interface elements can comprise one or more selectable values. An interface such as a user interface or API comprising one or more of the interface elements can be presented. A selection of the one or more selectable values associated with one or more interface elements can be received. As such, a plug-in instance can be generated based upon the one or more configuration options and the selected values of the one or more selectable values. As an example, the generated plug-in instance can be associated with the selected plug-in identifier.

In yet another aspect, methods for generating a plug-in instance can comprise receiving a selection of a configuration file comprising one or more configuration options. As an example, each of the one or more configuration options comprises an identifier and parameter information. An interface element can be generated for each of the one or more configuration options based on the identifier and the parameter information associated with the one or more configuration options. As an example, each of the generated interface elements can comprise one or more selectable values. An interface such as a user interface or API comprising one or more of the interface elements can be presented. As an example, an arrangement of the one or more interface elements is based upon the parameter information associated with the one or more configuration options. A selection of the one or more selectable values associated with one or more interface elements can be received. As such, a plug-in instance can be generated based upon configuration file and the selected values of the one or more selectable values.

Additional advantages will be set forth in part in the description which follows or may be learned by practice. The advantages will be realized and attained by means of the elements and combinations particularly pointed out in the appended claims. It is to be understood that both the foregoing general description and the following detailed description are exemplary and explanatory only and are not restrictive, as claimed.

### BRIEF DESCRIPTION OF THE DRAWINGS

The accompanying drawings, which are incorporated in and constitute a part of this specification, illustrate embodiments and together with the description, serve to explain the principles of the methods and systems:

FIG. 1A is a block diagram of an exemplary network;

FIG. 1B is a representation of an exemplary interface;

FIG. 1C is a representation of an exemplary interface;

FIG. 1D is a representation of an exemplary interface;

FIG. 1E is a representation of an exemplary interface;

FIG. 2 is a representation of an exemplary interface;

FIG. 3 is a representation of an exemplary interface;

FIG. 4 is a flow chart of an exemplary method for generating a software component;

FIG. 5A; is a flow chart of an exemplary method for generating a software component;

FIG. 5B; is a flow chart of an exemplary method for generating a software component; and

FIG. 6 is a block diagram of an exemplary computing system.

### DETAILED DESCRIPTION

Before the present methods and systems are disclosed and described, it is to be understood that the methods and systems are not limited to specific methods, specific components, or to particular implementations. It is also to be understood that the terminology used herein is for the purpose of describing particular embodiments only and is not intended to be limiting.

As used in the specification and the appended claims, the singular forms “a,” “an,” and “the” include plural referents unless the context clearly dictates otherwise. Ranges may be expressed herein as from “about” one particular value, and/or to “about” another particular value. When such a range is expressed, another embodiment includes from the one particular value and/or to the other particular value. Similarly, when values are expressed as approximations, by use of the antecedent “about,” it will be understood that the particular value forms another embodiment. It will be further understood that the endpoints of each of the ranges are significant both in relation to the other endpoint, and independently of the other endpoint.

“Optional” or “optionally” means that the subsequently described event or circumstance may or may not occur, and that the description includes instances where said event or circumstance occurs and instances where it does not.

Throughout the description and claims of this specification, the word “comprise” and variations of the word, such as “comprising” and “comprises,” means “including but not limited to,” and is not intended to exclude, for example, other components, integers or steps. “Exemplary” means “an example of” and is not intended to convey an indication of a preferred or ideal embodiment, “Such as” is not used in a restrictive sense, but for explanatory purposes.

Disclosed are components that can be used to perform the disclosed methods and systems. These and other components are disclosed herein, and it is understood that when combinations, subsets, interactions, groups, etc. of these components are disclosed that while specific reference of each various individual and collective combinations and permutation of these may not be explicitly disclosed, each is specifically contemplated and described herein, for all methods and systems. This applies to all aspects of this application including, but not limited to, steps in disclosed methods. Thus, if there are a variety of additional steps that can be performed it is understood that each of these additional steps can be performed with any specific embodiment or combination of embodiments of the disclosed methods.

The present methods and systems may be understood more readily by reference to the following detailed description of preferred embodiments and the examples included therein and to the Figures and their previous and following description.

As will be appreciated by one skilled in the art, the methods and systems may take the form of an entirely hardware embodiment, an entirely software embodiment, or an embodiment combining software and hardware aspects. Furthermore, the methods and systems may take the form of a computer program product on a computer-readable storage medium having computer-readable program instructions (e.g., computer software) embodied in the storage medium. More particularly, the present methods and systems may take the form of web-implemented computer software. Any suitable computer-readable storage medium may be utilized including hard disks, CD-ROMs, optical storage devices, or magnetic storage devices.

Embodiments of the methods and systems are described below with reference to block diagrams and flowchart illustrations of methods, systems, apparatuses and computer program products. It will be understood that each block of the block diagrams and flowchart illustrations, and combinations of blocks in the block diagrams and flowchart illustrations, respectively, can be implemented by computer program instructions. These computer program instructions may be loaded onto a general purpose computer, special purpose computer, or other programmable data processing apparatus to produce a machine, such that the instructions which execute on the computer or other programmable data processing apparatus create a means for implementing the functions specified in the flowchart block or blocks.

These computer program instructions may also be stored in a computer-readable memory that can direct a computer or other programmable data processing apparatus to function in a particular manner, such that the instructions stored in the computer-readable memory produce an article of manufacture including computer-readable instructions for implementing the function specified in the flowchart block or blocks. The computer program instructions may also be loaded onto a computer or other programmable data processing apparatus to cause a series of operational steps to be performed on the computer or other programmable apparatus to produce a computer-implemented process such that the instructions that execute on the computer or other programmable apparatus provide steps for implementing the functions specified in the flowchart block or blocks.

Accordingly, blocks of the block diagrams and flowchart illustrations support combinations of means for performing the specified functions, combinations of steps for performing the specified functions and program instruction means for performing the specified functions. It will also be understood that each block of the block diagrams and flowchart illustrations, and combinations of blocks in the block diagrams and flowchart illustrations, can be implemented by special purpose hardware-based computer systems that perform the specified functions or steps, or combinations of special purpose hardware and computer instructions.

Provided are methods and systems for generating software components for adding abilities to applications, often referred to as plug-ins. In an aspect, a interface such as a user interface or API is automatically generated and/or updated to define and present selectable configuration parameters for a particular plug-in.

FIG. 1A illustrates various aspects of an exemplary network in which the present methods and systems can operate. The present disclosure relates to systems and methods for generating one or more software components such as plug-in instances. Those skilled in the art will appreciate that present methods may be used in systems that employ bath digital and analog equipment. One skilled in the art will appreciate that provided herein is a functional description and that the respective functions can be performed by software, hardware, or a combination of software and hardware.

The network 100 can comprise a user device 102 in communication with a computing device 104, such as a server, for example. The computing device 104 can be disposed locally or remotely relative to the user device 102. As an example, the user device 102 and the computing device 104 can be in communication via a private or public network such as the Internet. Other forms of communications can be used, such as wired and wireless telecommunication channels, for example.

In an aspect, the user device 102 can be an electronic device such as a computer, a smartphone, a laptop, a tablet, a set top box, or other device capable of communicating with the computing device 104. As an example, the user device 102 can comprise a web browser 106 for providing an interface to a user to interact with the user device 102 and/or the computing device 104. The web browser 106 can be any interface for presenting information to the user and receiving a user feedback such as Internet Explorer, Mozilla Firefox, Google Chrome, Safari, or the like. Other software, hardware, and/or interfaces can be used to provide communication between the user and one or more of the user device 102 and the computing device 104. As an example, the web browser 106 can request or query various files from a local source and/or a remote source.

In an aspect, the user device 102 can comprise an interface 108 such as a user interface or API. As an example, the interface 108 can comprise one or more of a display, an input device such as user-selectable buttons, an audio device, an interactive communication device, and the like. As a further example, interface 108 can comprise one or more interface elements 110. In an aspect, the interface elements 110 can comprise a menu, icon, user-selectable button, drop-down, slider bar, input field, and the like. As an example, one or more of the interface elements 110 can be configured to receive a selection or input from a user. As a further example, one or more of the interface elements 110 can be configured to represent one or more configuration options 112. In an aspect, the configuration options 112 can comprise selectable options or inputs relating to the configuration of one or more plug-ins, interfaces, extensions, software, and the like. FIGS. 1B-1E illustrate exemplary interface elements 110 comprising configuration options 112. As an example, the configuration options 112 can relate to file transformation plug-ins, content player plugins, content playback plug-ins, and the like. Any number of plug-in options, menus, interface elements, parameters, and the like can be presented to a user using the interface elements 110.

In an aspect, one or more software components such as plug-in instances can be generated based on one or more configuration options 112. As an example, a plug-in instance can comprise a plug-in or extension having particular configurations and/or parameters. As a further example, a single plug-in or extension can provide a seed or base code for a plurality of plug-in instances. In an aspect, one or more plug-in instances can comprise a software component that adds specific abilities to another software application. As an example, one or more plug-in instances can be configured to customize the functionality of a particular software application.

In an aspect, a seed plug-in can comprise an unconfigured set of code that, when configured, can be used to generate one or more software components such as plug-in instances. As an example, a seed plug-in can be configured based on a first set of values for one or more associated configuration options 112 to generate a first plug-in instance. As a further example, the seed plug-in can be configured based on a second set of values for one or more associated configuration options 112 to generate a second plug-in instance. As such, the same seed plug-in can be configured to generate a plurality of plug-in instances based upon values associated with the configuration options 112.

In an aspect, a seed plug-in can be received (e.g., retrieved, loaded, selected, etc.). In another aspect, the seed plug-in can have one or more configuration options 112 associated therewith. As an example, each of the one or more configuration options 112 can comprise parameter information. In an aspect, the parameter information for the one or more configuration options can comprise one or more data fields such as name, type, requirement, array, protection, label, description, units, allowed values, minimum value, maximum value, visibility, or order, or a combination thereof. Other data fields can be used. As an example, a configuration file can comprise the one or more configuration options 112. As a further example, the one or more configuration options 112 can be associated with a particular plug-in or software. As such, a selection of values for one or more of the configuration options 112 can result in the generation of a software component such as a plug-in instance.

In an aspect, one or more interface elements 110 can be automatically customized to present specific input fields in a specific manner based upon a particular file, plug-in, data set, or the like that is being configured. As an example, a drop down menu can be presented for a configuration option 112 representing a file type. As another example, a fillable field can be presented for the configuration options 112 representing file name. As a further example, a fillable field with defined maximum and minimum values can be presented for configuration options 112 representing width, height, and sharpness. Other options and presentation can be used.

In an aspect, each of the generated interface elements 110 can comprise one or more selectable values. As a further example, the one or more selectable values can be based upon parameters associated with the one or more configuration options 112. In an aspect, each of the one or more configuration options 112 can be mapped to an interface element 110. As an example, one or more configuration options 112 can be mapped to a control element (e.g., interface element 110) such as a drop-down menu, a fillable field, a roll-over element, an executable, and the like. As a further example, one or more configuration options 112 can be mapped to a graphic element (e.g., interface element 110) such as an icon, menu, banner, and the like.

In FIGS. 1B-1E, one or more configuration options 112 can be associated with one or more interface elements 110. In an aspect, one or more interface elements 110 can facilitate the selection of one or more of the configuration options 112. As an example, selection of one or more of the configuration options 112 and/or the associated interface elements 110 can comprise inputting a value, associating an input with one or more of the configuration options 112, selecting a value from a group of predetermined values, providing a default designation, and the like. In an aspect, a group of configuration options 112 and associated interface elements 110 can be associated with a particular data set, such as a file, a seed plug-in, an extension, or the like. As an example, a first file can comprise the configuration options 112 represented in FIG. 1B. As another example, a second file can comprise the configuration options 112 represented in FIG. 1C. As a further example, a third file can comprise the configuration options 112 in FIG. 1D. In an aspect, one or more of a plurality of data sets (e.g., files, seed plug-ins, etc.) can comprise a defined group of configuration options 112, wherein one or more of the configuration options 112 can be represented by a specific interface element 110. As an example, a first file can comprise a configuration option 112 relating to a file type input field, which can be represented by a drop down menu of a finite group selectable file types. As a further example, a second file can comprise the configuration option 112 relating to a file type input field, which can be represented by a tillable field of any character combination or string. As such, the presentation of interface elements 110 can be customized based upon the particular data set that is being configured.

In FIG. 1E, a seed plug-in can comprise one or more configuration options 112, such as: encode as, file name, and fragment length, for example. In an aspect, the one or more configuration options 112 can be associated with one or more interface elements 110. Accordingly, when the seed plug-in is received, the interface elements 110 can be presented to a user to facilitate the selection of the configuration options 112. Once the interface elements 110 associated with one or more configuration options 112 are selected, a plug-in instance can be generated based upon the seed plug-in and the selected configuration options 112.

Returning to FIG. 1A, in an aspect, one or more of the configuration options 112 can comprise one or more parameters 114. As an example, parameters 114 can comprise data fields such as name, type, requirement, protection, label, description, units, allowable values, visibility, or order, or a combination thereof. The name data field can comprise an identifier of the parameter for the plug-in. The type data field can comprise a raw data type. The requirement data field can comprise an indication of whether the configuration option must have a specified value. For example, an array data field can comprise an indication of whether the raw data type is an array or a single value. The protection data field can comprise an indication of whether the configuration option represents sensitive information, such as a password. The label data field can comprise an identifier presented to end-users via an interface such as a user interface or API. The description data field can comprise a tooltip. As an example, the tooltip can be presented via an interface when an end-user hovers over a designated portion of the interface. The units data field can comprise units of measurement, tables, or classifier information relating to the configuration options. The allowed values data field can comprise information relating to limitations on acceptable values. As an example, a minValue data field can comprise the minimal value for a scalar parameter. As a further example, a maxValue data field can comprise the maximum value for a scalar parameter. The visibility data field comprises information relating to the manner of placement and/or position of a particular configuration option. The order data field can comprise an ordering or sequence of an array of values. The parameters 114 can comprise data fields that are similar in function to those described herein. Other parameters 114 can be used to represent various aspects of the configuration options or other data fields.

In an aspect, the one or more configuration options 112 can be stored and can be updated at any time. As an example, when a plug-in instance is required, selections of parameters of the one or more configuration options 112 can be used to customize the plug-in instance without the need to deploy new software or new interface elements. As a further example, the one or more configuration options 112 can be analyzed to dynamically generate an interface to receive selection of the parameters 114 associated with the one or more configuration options 112.

In an aspect, a software component such as plug-in instance 116 can be stored and/or executed via the user device 102. As an example, the plug-in instance 116 can comprise a plug-in or extension having particular configurations and/or parameters. As a further example, a single plug-in or extension can provide a seed or base code for a plurality of plug-in instances 116. In an aspect, one or more plug-in instances 116 can comprise a software component that adds specific abilities to another software application. As an example, one or inure plug-in instances 116 can be configured to customize the functionality of a particular software application. As a another example, one or more plug-in instances can be configured to extend functionality of the web browser 106 to play video, scan for viruses, display new file types, etc. As a further example, one or more plug-in instances can be configured to control file transformations or aspects of a content playback experience, or a combination thereof. For file transformation, one or more plug-in instances can be configured to convert one file format to another format, merge files, separate files into chapters, remove audio from a file, add or “burn in” captioning information, perform quality control (QC) checks, analyze metadata, apply digital rights management, or fragment a file into playable chunks, or a combination thereof. For playback control, one or more plug-in instances can be configured to insert advertisements, capture analytics, add additional controls to the content player, support social media integration, enable playback on custom content delivery networks, or provide visualization of waveforms, or a combination thereof. Other functions and controls can be enabled by one or more plug-ins and/or plug-in instances.

In an aspect, one or more software components such as plug-ins or plug-in instance 116 can be associated with an identifier 118. As an example, a seed plug-in used to generate one or more plug-in instances 116 can be associated with the identifier 118 for retrieval, selection, and/or tracking of the seed plug-in. As a further example, each of one or more of the plug-in instances 116 can be associated with the identifier 118 to differentiate between the plug-in instances 116. In an aspect, a configuration file representing one or more configuration options 112 associated with a particular plug-in or plug-in instance 116 can be associated with the identifier 118. As such, a user can select the identifier 118 to retrieve the data associated with the identifier 118. As an example, the identifier 118 can be a name, string, hash, locator, pointer, address, and the like.

In an aspect, the computing device 104 can be software or hardware for communicating with the user device 102. As an example, the computing device 104 can manage the intercommunication between the user device 102 and the database 120 for sending and receiving data therebetween. In an aspect, the database 120 can store a plurality of files (e.g. web pages). As an example, the user device 102 can request a file from the database 120. As a further example, the user device 102 can retrieve a file from the database 120. In an aspect, the database 120 can comprise the configuration options 112. As an example, a group of configuration options 112 can be stored as a configuration file. As a further example, the parameters associated with configuration options 112 of a particular plug-in can be stored as a configuration file.

In an aspect, the user device 102 can be in communication with dedicated software to consume various media types. As an example, the software can be executed on the user device 102. The software can provide the various media types to the user device 102 directly or establish a connection to a source of the media types such as the computing device 104 or database 120, for example. As a further example, the software can be executed remotely relative to the user device 102. In an aspect, the media type presented on the user device 102 is based upon the class identifier 112 associated with the user or user device 102.

In an aspect, software can be used to implement methods for generating a software component such as a plug-in instance. The methods and systems can comprise a software interface 200, as illustrated in FIG. 2. By way of example, the interface 200 can be integrated with the web browser 106. As a further example, the interface 200 can be loaded to the user device 102 as an add-on software package.

The methods and systems disclosed can utilize one or more interfaces 200 to perform one or more functions in one or more locations. FIG. 2 illustrates an exemplary interface 200 for performing the disclosed methods. This exemplary interface 200 is only an example of an interface and is not intended to suggest any limitation as to the scope of use or functionality of interface architecture. Neither should the interface 200 be interpreted as having any dependency or requirement relating to any one or combination of components illustrated in the interface 200.

In an aspect, the web browser 106 can comprise a browser window 202 for displaying information (e.g. web pages, files, etc.) to the user. As an example, the web browser 106 can comprise an address bar 204 or URL bar to allow a user to input a URL for directing the requests of the web browser 106. In an aspect, the interface 200 can be a toolbar disposed adjacent the address bar 204 of the web browser 106 and including one or more interface elements, buttons, or engageable menus. The interface 200 can be presented to the user in any position, form, and environment. As an example, the interface 200 can comprise a plurality of interface elements, such as user-engageable buttons 206 for executing various associated functions (e.g. search function, settings modification, and the like.)

In an aspect, the interface 200 can comprise an interface element such as home button, a homepage button for directing the web browser 106 to a pre-defined file or webpage, and/or a plug-in, extension, or an application 208 requiring a plug-in or extension.

In an aspect, a plug-in instance 210 can be executed when software requires the functionality provided by the plug-in instance. As an example, the interface 200 can present at least a portion of the executed plug-in instance 210. As another example, the plug-in instance 210 can be configured and/or customized based upon one or more of the configuration options 112. As a further example, the plug-in instance can enable specific customizable functionality to a software application, such as application 208.

In an aspect, software can be used to implement methods for generating a plug-in instance. As an example, the software can comprise an interface for enabling selection of one or more configuration options associated with one or more plug-ins. The methods and systems can comprise a software interface 300, as illustrated in FIG. 3. By way of example, the interface 300 can be integrated with the web browser 106. As a further example, the interface 300 can be loaded to the user device 102 as an add-on software package.

In an aspect, the interface 300 can comprise one or more input fields 302 (e.g., interface elements 110) such as menus, icons, drop-down menus, fillable fields, and the like. As an example, one or more configuration options 112 can be represented by the input fields 302. As a further example, each of the input fields can facilitate the selection of one or more values for each of the configuration options 112 presented. In an aspect, the parameters 114 associated with each of the configuration options 112 can define the manner and/or position in which the input fields 302 are presented. Accordingly, the interface 300 can be automatically customized to present specific input fields 302 in a specific manner based upon a particular plug-in that is being configured and/or the configuration options 112 associated with the particular plug-in. As an example, a drop down menu can be presented for the configuration options 112 representing file type. As another example, a tillable field can be presented for the control options representing file name. As a further example, fillable fields with defined maximum and minimum values can be presented for configuration options 112 representing width, height, and sharpness. Other options and presentation can be used.

In an aspect, when a data set (e.g., file, seed plug-in, etc.) is selected, the interface 300 can represent one or more configuration options 112 associated with the selected data set. As an example, the input fields 302 can be presented to a user to facilitate the selection of the configuration options 112. As a further example, selection of one or more of the configuration options 112 and/or the associated input fields 302 can comprise inputting a value, associating an input with one or more of the configuration options 112, selecting a value from a group of predetermined values, providing a default designation, and the like. Once the configuration options 112 are selected, a plug-in instance can be generated based upon the seed plug-in and the selected configuration options 112.

FIG. 4 illustrates an exemplary method for generating software components. In step 402, one or more configuration options can be received. In an aspect, each of the one or more configuration options comprises parameter information, such as one or more parameters and/or one or more values associated with the one or more parameters. As an example, a configuration file can comprise the one or more configuration options. As a further example, the one or more configuration options can be associated with a particular plug-in or software. As such, the selection of values for one or more of the configuration options can result in the generation of a plug-in instance. In an aspect, the parameter information for the one or more configuration options can comprise one or more data fields such as name, type, requirement, array, protection, label, description, units, allowed values, minimum value, maximum value, visibility, or order, or a combination thereof. Other data fields can be used.

In step 404, each of the one or more configuration options can be associated with an interface element. In an aspect, each of the one or more configuration options can be mapped to an interface element. As an example, each of the one or more configuration options can be associated with an interface element based on the parameter information associated with the one or more configuration options. In an aspect, one or more configuration options can be mapped to an interface element such as a drop-down menu, a fillable field, a roll-over element, an executable, and the like. As an example, one or more configuration options can be mapped to an interface graphic such as an icon, menu, banner, and the like.

In step 406, an interface such as a user interface or API can be presented. In an aspect, the interface can comprise one or more of the interface elements. As an example, the position and/or arrangement of the interface elements can be based upon the parameters associated with the configuration options mapped to the interface elements. As a further example, a particular configuration option can have a binary (e.g., Yes/No) parameter defining whether the configuration option is protected. As such, the configuration options having the binary parameter can be presented as an interface element having selectable radio buttons to indicate a yes or no selection. As another example, a particular configuration option can have a plurality of selectable parameters and can be presented as a drop-down menu. Other graphics and control elements can be presented as part of the interface.

In step 408, a selection of the one or more interface elements can be received. In an aspect, receiving a selection of the one or more interface elements can comprise receiving an input associated with one or more interface elements. In another aspect, receiving a selection of the one or more interface elements can comprise receiving an input relating to a configuration option associated with the interface element. As an example, the input can comprise engaging a button or selecting a value from a menu. As a further example, the input can comprise providing an alphanumeric entry or retrieving data.

In step 410, a software components such as a plug-in instance can be generated. In an aspect, the plug-in instance can be generated based upon the one or more configuration options mapped to the select one or more interface elements. As an example, each of a plurality of plug-in instances can be generated for the same plug-in, whereby each plug-in instance has different configurations. As a further example, the configuration options presented to the user as interface elements can facilitate the receipt of the configuration information used to generate the plug-in instance.

FIG. 5A illustrates an exemplary method for generating software components. In step 502, a selection of an identifier can be received. In an aspect, one or more plug-ins or plug-in instances can be associated with an identifier. As an example, a seed plug-in used to generate one or more plug-in instances can be associated with the identifier for retrieval, selection, and/or tracking of the seed plug-in. As a further example, each of one or more of the plug-in instances can be associated with a unique identifier to differentiate between the plug-in instances. In an aspect, a configuration file can be associated with the identifier. As such, a user can select the identifier to retrieve the data associated with the configuration file. As an example, the identifier can be a name, string, hash, locator, pointer, address, and the like. As a further example, receiving a selection of an identifier can comprise receiving a selection of a configuration file associated with a particular plug-in.

In step 504, one or more configuration options can be received. In an aspect, the received one or more configuration options can be associated with the identifier selected in step 502. As an example, each of the one or more configuration options can comprise parameter information. In an aspect, each of the one or more configuration options can comprise one or more parameters and/or one or more values associated with the one or more parameters. As an example, a configuration file can comprise the one or more configuration options. As a further example, the one or more configuration options can be associated with a particular plug-in or software. As such, a selection of values for one or more of the configuration options can result in the generation of a plug-in instance. In an aspect, the parameter information for the one or more configuration options can comprise one or more data fields, such as name, type, requirement, array, protection, label, description, units, allowed values, minimum value, maximum value, visibility, or order, or a combination thereof. Other data fields can be used.

In step 506, an interface element can be generated. In an aspect, an interface element can be generated for each of the one or more configuration options based on the identifier and/or parameter information associated with the one or more configuration options. As another example, each of the generated interface elements can comprise one or more selectable values. As a further example, the one or more selectable values can be based upon the parameters associated with the one or more configuration options. In an aspect, each of the one or more configuration options can be mapped to an interface element. As an example, one or more configuration options can be mapped to an interface control, such as a drop-down menu, a finable field, a roll-over element, an executable, and the like. As a further example, one or more configuration options can be mapped to an interface graphic, such as an icon, menu, banner, and the like.

In step 508, an interface such as a user interface or API can be presented. In an aspect, the interface can comprise one or more of the interface elements. As an example, the position and/or arrangement of the interface elements can be based upon the parameters associated with the configuration options mapped to the interface elements. As a further example, a particular configuration option can have a binary (e.g., Yes/No) parameter defining whether the configuration option is protected. As such, the configuration options having the binary parameter can be presented as an interface element having selectable radio buttons to indicate a yes or no selection. As another example, a particular configuration option can have a plurality of selectable parameters and can be presented as a drop-down menu. Other graphics and control elements can be presented as part of the interface.

In step 510, a selection of the one or more selectable values associated with one or more interface elements can be received. In an aspect, receiving a selection of the one or more selectable values can comprise receiving an input associated with one or more interface elements. In another aspect, receiving a selection of the one or more selectable values can comprise receiving an input relating to a configuration option associated with the interface element. As an example, the input can comprise engaging a button or selecting a value from a menu. As a further example, the input can comprise providing an alphanumeric entry or retrieving data.

In step 512, a software components such as a plug-in instance can be generated based upon the one or more configuration options and/or the selected values of the one or more selectable values. In an aspect, the generated plug-in instance can be associated with the selected plug-in identifier. In another aspect, the plug-in instance can be generated based upon the one or more configuration options mapped to the select one or more interface elements. As an example, each of a plurality of plug-in instance can be generated for the same plug-in, whereby each plug-in instance has different configurations. As a further example, the configuration options presented to the user as interface elements can facilitate the receipt of the configuration information used to generate the plug-in instance.

FIG. 5B illustrates an exemplary method for generating a plug-in instance. In step 522, a selection of configuration information can be received. In an aspect, a dataset such as a configuration file can comprise configuration information such as one or more configuration options. Accordingly, a selection of configuration information can comprise a selection of one or more data sets.

In step 524, one or more configuration options can be received. In an aspect, the received one or more configuration options can be associated with the configuration information selected in step 522. As an example, each of the one or more configuration options can comprise parameter information. In an aspect, each of the one or more configuration options can comprise one or more parameters and/or one or more values associated with the one or more parameters. As an example, a configuration file can comprise the one or more configuration options. As a further example, the one or more configuration options can be associated with a particular plug-in or software. As such, a selection of values for one or more of the configuration options can result in the generation of a plug-in instance. In an aspect, the parameter information for the one or more configuration options can comprise one or more data fields, such as: name, type, requirement, array, protection, label, description, units, allowed values, minimum value, maximum value, visibility, or order, or a combination thereof. Other data fields can be used.

In step 526, an interface element can be generated. In an aspect, an interface element can be generated for each of the one or more configuration options based on the identifier and/or parameter information associated with the one or more configuration options. As another example, each of the generated interface elements can comprise one or more selectable values. As a further example, the one or more selectable values can be based upon the parameters associated with the one or more configuration options. In an aspect, each of the one or more configuration options can be mapped to an interface element. As an example, one or more configuration options can be mapped to an interface control, such as a drop-down menu, a tillable field, a roll-over element, an executable, and the like. As a further example, one or more configuration options can be mapped to an interface graphic, such as an icon, menu, banner, and the like.

In step 528, an interface such as a user interface or API can be presented. In an aspect, the interface can comprise one or more of the interface elements. As an example, the position and/or arrangement of the interface elements can be based upon the parameters associated with the configuration options mapped to the interface elements. As a further example, a particular configuration option can have a binary (e.g., Yes/No) parameter defining whether the configuration option is protected. As such, the configuration options having the binary parameter can be presented as an interface element having selectable radio buttons to indicate a yes or no selection. As another example, a particular configuration option can have a plurality of selectable parameters and can be presented as a drop-down menu. Other graphics and control elements can be presented as part of the interface.

In step 530, a selection of the one or more selectable values associated with one or more interface elements can be received. In an aspect, receiving a selection of the one or more selectable values can comprise receiving an input associated with one or more interface elements. In another aspect, receiving a selection of the one or more selectable values can comprise receiving an input relating to a configuration option associated with the interface element. As an example, the input can comprise engaging a button or selecting a value from a menu. As a further example, the input can comprise providing an alphanumeric entry or retrieving data.

In step 532, a software component such as a plug-in instance can be generated based upon the one or more configuration options and/or the selected values of the one or more selectable values. In an aspect, the generated plug-in instance can be associated with the selected plug-in identifier, in another aspect, the plug-in instance can be generated based upon the one or more configuration options mapped to the select one or more interface elements. As an example, each of a plurality of plug-in instance can be generated for the same plug-in, whereby each plug-in instance has different configurations. As a further example, the configuration options presented to the user as interface elements can facilitate the receipt of the configuration information used to generate the plug-in instance.

In an exemplary aspect, the methods and systems can be implemented on a computing system such as computing device 601 as illustrated in FIG. 6 and described below. By way of example, one or more of the user device 102 and the computing device 104 of FIG. 1 can be a computer as illustrated in FIG. 6. Similarly, the methods and systems disclosed can utilize one or more computers to perform one or more functions in one or more locations. FIG. 6 is a block diagram illustrating an exemplary operating environment for performing the disclosed methods. This exemplary operating environment is only an example of an operating environment and is not intended to suggest any limitation as to the scope of use or functionality of operating environment architecture. Neither should the operating environment be interpreted as having any dependency or requirement relating to any one or combination of components illustrated in the exemplary operating environment.

The present methods and systems can be operational with numerous other general purpose or special purpose computing system environments or configurations. Examples of well known computing systems, environments, and/or configurations that can be suitable for use with the systems and methods comprise, hut are not limited to, personal computers, server computers, laptop devices, and multiprocessor systems. Additional examples comprise set top boxes, programmable consumer electronics, network PCs, minicomputers, mainframe computers, distributed computing environments that comprise any of the above systems or devices, and the like.

The processing of the disclosed methods and systems can be performed by software components. The disclosed systems and methods can be described in the general context of computer-executable instructions, such as program modules, being executed by one or more computers or other devices. Generally, program modules comprise computer code, routines, programs, objects, components, data structures, etc. that perform particular tasks or implement particular abstract data types. The disclosed methods can also be practiced in grid-based and distributed computing environments where tasks are performed by remote processing devices that are linked through a communications network. In a distributed computing environment, program modules can be located in both local and remote computer storage media including memory storage devices.

Further, one skilled in the art will appreciate that the systems and methods disclosed herein can be implemented via a general-purpose computing device in the form of a computing device 601. The components of the computing device 601 can comprise, but are not limited to, one or more processors or processing units 603, a system memory 612, and a system bus 613 that couples various system components including the processor 603 to the system memory 612. In the case of multiple processing units 603, the system can utilize parallel computing.

The system bus 613 represents one or more of several possible types of bus structures, including a memory bus or memory controller, a peripheral bus, an accelerated graphics port, and a processor or local bus using any of a variety of bus architectures. By way of example, such architectures can comprise an Industry Standard Architecture (ISA) bus, a Micro Channel Architecture (MCA) bus, an Enhanced ISA (EISA) bus, a Video Electronics Standards Association (VESA) local bus, an Accelerated Graphics Port (AG-P) bus, and a Peripheral Component Interconnects (PCI), a PCI-Express bus, a Personal Computer Memory Card Industry Association (PCMCIA), Universal Serial Bus (USB) and the like. The bus 613, and all buses specified in this description can also be implemented over a wired or wireless network connection and each of the subsystems, including the processor 603, a mass storage device 604, an operating system 605, configuration software 606, configuration data 607, a network adapter 608, system memory 612, an Input/Output Interface 610, a display adapter 609, a display device 611, and a human machine interface 602, can be contained within one or more remote computing devices 614a,b,c at physically separate locations, connected through buses of this form, in effect implementing a fully distributed system.

The computing device 601 typically comprises a variety of computer readable media. Exemplary readable media can be any available media that is accessible by the computing device 601 and comprises, for example and not meant to be limiting, both volatile and non-volatile media, removable and non-removable media. The system memory 612 comprises computer readable media in the form of volatile memory, such as random access memory (RAM), and/or non-volatile memory, such as read only memory (ROM). The system memory 612 typically contains data such as configuration data 607 and/or program modules such as operating system 605 and configuration software 606 that are immediately accessible to and/or are presently operated on by the processing unit 603.

In another aspect, the computing device 601 can also comprise other removable/non-removable, volatile/non-volatile computer storage media. By way of example, FIG. 6 illustrates a mass storage device 604 which can provide non-volatile storage of computer code, computer readable instructions, data structures, program modules, and other data for the computing device 601. For example and not meant to be limiting, a mass storage device 604 can be a hard disk, a removable magnetic disk, a removable optical disk, magnetic cassettes or other magnetic storage devices, flash memory cards, CD-ROM, digital versatile disks (DVD) or other optical storage, random access memories (RAM), read only memories (ROM), electrically erasable programmable read-only memory (EEPROM), and the like.

Optionally, any number of program modules can be stored on the mass storage device 604, including by way of example, an operating system 605 and configuration software 606. Each of the operating system 605 and configuration software 606 (or some combination thereof) can comprise elements of the programming and the configuration software 606. Configuration data 607 can also be stored on the mass storage device 604. Configuration data 607 can be stored in any of one or more databases known in the art. Examples of such databases comprise, DB2®, Microsoft® Access, Microsoft® SQL Server, Oracle®, mySQL, PostgreSQL, and the like. The databases can be centralized or distributed across multiple systems.

In another aspect, the user can enter commands and information into the computing device 601 via an input device (not shown). Examples of such input devices comprise, but are not limited to, a keyboard, pointing device a “mouse”), a microphone, a joystick, a scanner, tactile input devices such as gloves, and other body coverings, and the like These and other input devices can be connected to the processing unit 603 via a human machine interface 602 that is coupled to the system bus 613, but can be connected by other interface and bus structures, such as a parallel port, game port, an IEEE 1394 Port (also known as a Firewire port), a serial port, or a universal serial bus (USB).

In yet another aspect, a display device 611 can also be connected to the system bus 613 via an interface, such as a display adapter 609. It is contemplated that the computing device 601 can have more than one display adapter 609 and the computer 601 can have more than one display device 611. For example, a display device can be a monitor, an LCD (Liquid Crystal Display), or a projector. In addition to the display device 611, other output peripheral devices can comprise components such as speakers (not shown) and a printer (not shown) which can be connected to the computing device 601 via Input/Output Interface 610. Any step and/or result of the methods can be output in any form to an output device. Such output can be any form of visual representation, including, but not limited to, textual, graphical, animation, audio, tactile, and the like. The display 611 and computing device 601 can be part of one device, or separate devices.

The computing device 601 can operate in a networked environment using logical connections to one or more remote computing devices 614a,b,c. By way of example, a remote computing device can be a personal computer, portable computer, a smart phone, a server, a router, a network computer, a peer device or other common network node, and so on. Logical connections between the computing device 601 and a remote computing device 614a,b,c can be made via a network 615, such as a local area network (LAN) and a general wide area network (WAN). Such network connections can be through a network adapter 608. A network adapter 608 can be implemented in both wired and wireless environments. Such networking environments are conventional and commonplace in dwellings, offices, enterprise-wide computer networks, intranets, and the Internet.

For purposes of illustration, application programs and other executable program components such as the operating system 605 are illustrated herein as discrete blocks, although it is recognized that such programs and components reside at various times in different storage components of the computing device 601, and are executed by the data processor(s) of the computer. An implementation of configuration software 606 can be stored on or transmitted across some form of computer readable media. Any of the disclosed methods can be performed by computer readable instructions embodied on computer readable media. Computer readable media can be any available media that can be accessed by a computer. By way of example and not meant to be limiting, computer readable media can comprise “computer storage media” and “communications media.” “Computer storage media” comprise volatile and non-volatile, removable and non-removable media implemented in any methods or technology for storage of information such as computer readable instructions, data structures, program modules, or other data. Exemplary computer storage media comprises, but is not limited to, RAM, ROM, EEPROM, flash memory or other memory technology, CD-ROM, digital versatile disks (DVD) or other optical storage, magnetic cassettes, magnetic tape, magnetic disk storage or other magnetic storage devices, or any other medium which can be used to store the desired information and which can be accessed by a computer.

The methods and systems can employ Artificial Intelligence techniques such as machine learning and iterative learning. Examples of such techniques include, but are not limited to, expert systems, case based reasoning, Bayesian networks, behavior based AI, neural networks, fuzzy systems, evolutionary computation (e.g. genetic algorithms), swarm intelligence (e.g. ant algorithms), and hybrid intelligent systems (e.g. Expert inference rules generated through a neural network or production rules from statistical learning).

While the methods and systems have been described in connection with preferred embodiments and specific examples, it is not intended that the scope be limited to the particular embodiments set forth, as the embodiments herein are intended in all respects to be illustrative rather than restrictive.

Unless otherwise expressly stated, it is in no way intended that any method set forth herein be construed as requiring that its steps be performed in a specific order. Accordingly, where a method claim does not actually recite an order to be followed by its steps or it is not otherwise specifically stated in the claims or descriptions that the steps are to be limited to a specific order, it is no way intended that an order be inferred, in any respect. This holds for any possible non-express basis for interpretation, including: matters of logic with respect to arrangement of steps or operational flow; plain meaning derived from grammatical organization or punctuation; the number or type of embodiments described in the specification.

It will be apparent to those skilled in the art that various modifications and variations can be made without departing from the scope or spirit. Other embodiments will be apparent to those skilled in the art from consideration of the specification and practice disclosed herein. It is intended that the specification and examples be considered as exemplary only, with a true scope and spirit being indicated by the following claims.

What is claimed is:

1. A method comprising:
receiving one or more configuration options, wherein each of the one or more configuration options comprises parameter information;
mapping each of the one or more configuration options to an interface element based on the parameter information associated with the one or more configuration options;
presenting an interface comprising one or more of the interface elements;
receiving a selection of the one or more interface elements; and
generating a plug-in instance based upon the one or more configuration options mapped to the select one or more interface elements.

2. The method of claim 1, wherein the one or more configuration options are comprised in a configuration file.

3. The method of claim 1, wherein the parameter information for the one or more configuration options comprises one or more data fields.

4. The method of claim 3, wherein the data fields comprise name, type, requirement, array, protection, label, description, units, allowed values, minimum value, maximum value, visibility, or order, or a combination thereof.

5. The method of claim 1, wherein mapping each of the one or more configuration options to an interface element comprises generating an interface control associated with the interface element.

6. The method of claim 1, wherein mapping each of the one or more configuration options to an interface element comprises defining an interface graphic associated with the interface element.

7. The method of claim 1, wherein receiving a selection of the one or more interface elements comprises receiving an input associated with one or more interface elements.

8. The method of claim 1, wherein the interface comprises one or more of an application program interface and a user interface.

9. A method comprising:
receiving a selection of an identifier;
receiving one or more configuration options associated with the identifier, wherein each of the one or more configuration options comprises parameter information;
generating an interface element for each of the one or more configuration options based on the identifier and parameter information associated with the one or more configuration options, wherein each of the generated interface elements comprises one or more selectable values;
presenting an interface comprising one or more of the interface elements;
receiving a selection of the one or more selectable values associated with one or more interface elements; and
generating a software component based upon the one or more configuration options and the selected values of the one or more selectable values, wherein the generated software component is associated with the selected identifier.

10. The method of claim 9, wherein the one or more configuration options are comprised in a configuration file.

11. The method of claim 9, wherein the parameter information for the one or more configuration options relates to a name, type, requirement, array, protection, label, description, units, allowed values, minimum value, maximum value, visibility, or order, or a combination thereof.

12. The method of claim 9, wherein generating an interface element comprises generating an interface control or an interface graphic associated with the interface element.

13. The method of claim 9, wherein receiving a selection of the one or more interface elements comprises receiving an input associated with one or more interface elements.

14. The method of claim 9, wherein the interface comprises one or more of an application program interface and a user interface.

15. The method of claim 9, wherein the software component is a plug-in instance.

16. A method comprising:
receiving a selection of a configuration file comprising one or more configuration options, wherein each of the one or more configuration options comprises an identifier and a parameter information;
generating an interface element for each of the one or more configuration options based on the identifier and the parameter information associated with the one or more configuration options, wherein each of the generated interface elements comprises one or more selectable values;
presenting an interface comprising one or more of the interface elements, wherein an arrangement of the one or more interface elements is based upon the parameter information associated with the one or more configuration options;
receiving a selection of the one or more selectable values associated with one or more interface elements; and
generating a software component based upon configuration file and the selected values of the one or more selectable values.

17. The method of claim 16, wherein the parameter information for the one or more configuration options relates to a name, type, requirement, array, protection, label, description, units, allowed values, minimum value, maximum value, visibility, or order, or a combination thereof.

18. The method of claim 16, wherein generating an interface element comprises generating one or more of an interface control associated with the interface element and an interface graphic associated with the interface element.

19. The method of claim 16, wherein the software component is a plug-in instance.

20. The method of claim 16, wherein the interface comprises one or more of an application program interface and a user interface.
